(19) United States
(12) Patent Application Publication
(10) Pub. No.: US 2005/0064980 A1
(43) Pub. Date: Mar. 24, 2005

(54) Geared motor

(76) Inventor: Kazuki Hoshi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/912,411

(22) Filed: Aug. 4, 2004

(30) Foreign Application Priority Data
Aug. 8, 2003 (JP) 2003-289743

(51) Int. Cl. F16H 59/60

(52) U.S. Cl. 475/257

(57) ABSTRACT

A geared motor includes a drive source, a deceleration transmission mechanism which is connected to the drive source for decelerating and transmitting a rotation output of the drive source to an output part, a first case which fixes the drive source, a second case which forms a space for accommodating the drive source together with the first case and supports the deceleration transmission mechanism, and a third case which covers the deceleration transmission mechanism. A part of the deceleration transmission mechanism is formed with the second case in an integral manner. For example, the deceleration transmission mechanism includes a planetary gear mechanism which comprises a sun gear which transmits the rotation output from the drive source, a planetary gear which revolves around the sun gear while rotating, and an internal gear which is integrally formed on the second case and engages with the planetary gear.

### CROSS REFERENCE TO RELATED APPLICATIONS

This application claims priority to Japanese Application No. 2003-289743 filed Aug. 8, 2003, which is incorporated herein by reference.

### BACKGROUND OF THE INVENTION

a) Field of the Invention

The present invention relates to a geared motor in which a deceleration transmission mechanism is integrated to a motor which is a drive source. Specifically, the present invention relates to a geared motor in which a case accommodating the drive source and the deceleration transmission mechanism is improved.

b) Description of the Related Art

A geared motor has been known in which a motor and a deceleration transmission mechanism are accommodated in a housing comprising an upper case and a lower case, and a mid partition plate is provided inside the housing as another member. (see Japanese Patent Laid-Open No. Hei 8-126251). The mid partition plate supports the shafts of the motor and the deceleration transmission mechanism. The internal mechanism can be efficiently accommodated in the housing by partitioning the inside of the upper and lower case with the mid partition plate.

Also, in recent years, an internal-gear has been sometimes used as a part of the deceleration transmission mechanism. The internal-gear is fixed to the upper and lower case or the mid partition plate.

However, in the geared motor provided with the mid partition plate described above, the shafts of the gears and the internal-gear and the mid partition plate are respectively required as discrete members and thus the number of component parts increases. Especially, when the internal gear is fixed to the mid partition plate, another member for fixing the internal gear is needed. In this case, since many component parts are required, it is difficult to adjust the distances between the shaft centers of the gears. In addition, it is necessary to calculate the strength of the respective fitting portions of the mid partition plate, the internal gear, and the upper and lower cases. When the number of component parts increases, the strength calculation becomes more complicated.

### OBJECT AND SUMMARY OF THE INVENTION

In view of the problems described above, it is an object and advantage of the present invention to provide a geared motor capable of reducing the number of component parts.

In order to achieve the above object and advantage, according to an embodiment of the present invention, there is provided a geared motor including a drive source, a deceleration transmission mechanism which is connected to the drive source for decelerating and transmitting the rotation output of the drive source to an output part, a first case which fixes the drive source, a second case which forms a space accommodating the drive source together with the first case and supports the deceleration transmission mechanism and a third case which covers the deceleration transmission mechanism. In the geared motor, a part of the deceleration transmission mechanism is formed with the second case in an integral manner.

Therefore, since one part of the deceleration transmission mechanism is integrally formed with the second case, the number of component parts can be reduced.

In accordance with an embodiment of the present invention, the deceleration transmission mechanism is provided with a planetary gear mechanism which includes a sun gear which transmits the rotation output from the drive source, a planetary gear which revolves around the sun gear while rotating, and an internal gear which is integrally formed on the second case and engages with the planetary gear. Further, in accordance with an embodiment of the present invention, the internal gear is formed on an inner peripheral face of an aperture part formed on the second case.

According to the construction described above, since the internal gear made as a discrete member is not required to mount on the second case as the conventional example, the number of component parts can be reduced.

In accordance with an embodiment of the present invention, a torque limiter is provided between the deceleration transmission mechanism and the output part, which operates to output the same torque as an input torque when the input torque is not more than a preset torque and not to output a torque when the input torque exceeds the preset torque. In this case, the geared motor is provided with the function of a torque limiter.

In accordance with an embodiment of the present invention, the second case is constructed so as to support the drive source. In this case, the second case is preferably provided with a support hole into which a motor as the drive source is inserted and supported, and a motor pinion is disposed between the second case and the third case. Therefore, since another member for supporting the drive source is not required, the increase of the number of component parts is suppressed.

As described above, in the geared motor in accordance with the embodiment of the present invention, since a part of the deceleration transmission mechanism and the second case are formed in an integral manner, the number of component parts can be reduced. Further, the drive source and the shaft of the gear can be fixed by using the second case and thus the center-distance of gears can be easily secured. Moreover, a part of the deceleration transmission mechanism and the second case are integrally formed and thus the calculation of strength can be easily performed and the strength can be enhanced.

Further, in the geared motor in accordance with the embodiment of the present invention, the internal gear included in the deceleration transmission mechanism is constructed so as to be formed on the second case in an integral manner. Therefore, the number of component parts for the internal gear and the member to be fixed therefor can be reduced.

In addition, in the geared motor in accordance with the embodiment of the present invention, the geared motor is provided with the function of a torque limiter.

Further, in the geared motor in accordance with the embodiment of the present invention, the second case is constructed so as to support the drive source. In this case, since another member for supporting the drive source is not required, the increase of the number of component parts can be suppressed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is an exploded view showing a geared motor viewed obliquely from above in accordance with an embodiment of the present invention;

FIG. 2 is an exploded view showing the geared motor shown in FIG. 1 obliquely from below;

FIG. 3 is a longitudinal cross sectional front view showing the geared motor;

FIGS. 4(A) and 4(B) show a torque limiter. FIG. 4(A) is a transversal cross sectional plan view showing the torque limiter which is cut by the line “A-A” in FIG. 4(B). FIG. 4(B) is a longitudinal cross sectional front view showing the torque limiter which is cut by the line “B-B” in FIG. 4(A); and

FIG. 5(A) is an exploded view showing the torque limiter viewed from obliquely above and

FIG. 5(B) is an exploded view showing the torque limiter from obliquely below.

### DETAILED DESCRIPTION OF THE PREFERRED EMBODIMENTS

An embodiment of the present invention will be described in detail below with reference to the accompanying drawings.

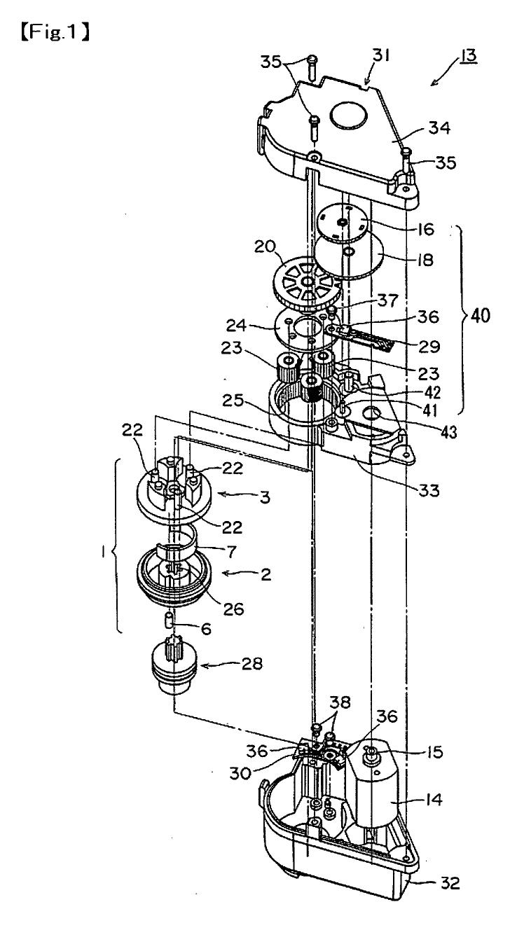

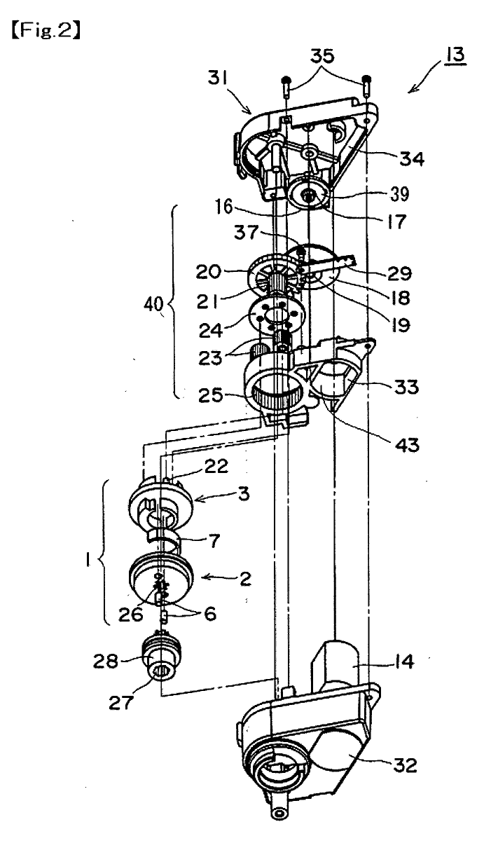

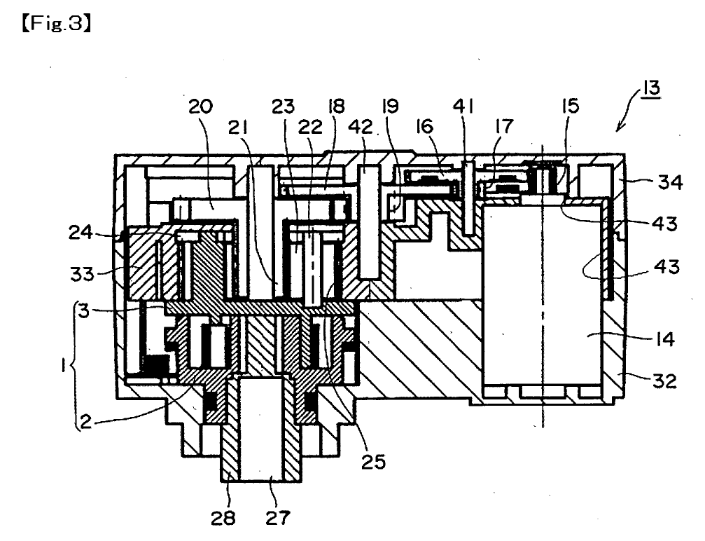

A geared motor 13 in accordance with an embodiment of the present invention is shown in FIGS. 1 through 3. The geared motor 13 includes a drive source (motor) 14, a deceleration transmission mechanism 40 which is connected to the drive source 14 to transmit the decelerated rotation output of the drive source 14 to an output part 28, a first case 32 for accommodating and fixing the drive source 14, a second case 33 which forms a space for being fitted and accommodating the drive source 14 together with the first case 32 and supports the deceleration transmission mechanism 40, and a third case 34 which covers the deceleration transmission mechanism 40. A part of the deceleration transmission mechanism 40 is formed with the second case 33 in an integral manner.

The deceleration transmission mechanism 40 includes a planetary gear mechanism which is provided with a sun gear 21 for transmitting a rotation output from the drive source 14, three planetary gears 23 which revolve around the sun gear 21 while rotating, and an internal gear 25 engaging with the planetary gears 23. The internal gear 25 is formed with the second case 33 in an integral manner. In other words, an aperture part is formed on the second case 33 and the internal gear 25 is directly formed on the internal peripheral face of the aperture part of the second case 33. As a result, the number of component parts can be reduced. The internal gear 25 formed on the internal face of the second case 33 is formed over the whole circumference.

A torque limiter 1 is provided between the deceleration transmission mechanism 40 and the output part 28. According to the construction having the torque limiter 1, the same torque as an input torque is outputted when the input torque is not more than a preset torque and the torque is not outputted when the input torque exceeds the preset torque.

In accordance with an embodiment of the present invention, the geared motor 13 is used for an automatic opening/closing unit for a toilet seat and a seat lid. The automatic opening/closing unit opens or closes the toilet seat or the seat lid by transmitting the power of the drive source 14 to the toilet seat or the seat lid.

The deceleration transmission mechanism 40 includes a pinion 15 fixed on the shaft of the drive source (motor) 14, a first gear 16 engaged with the pinion 15, a first pinion 17 which is coaxially integrated with the first gear 16, a second gear 18 engaged with the first pinion 17, a second pinion 19 which is coaxially integrated with the second gear 18, a third gear 20 engaged with the second pinion 19. The deceleration transmission mechanism 40 also includes a sun gear 21 which is coaxially integrated with the third gear 20, three support shafts 22 fixed to an upper wheel 3 of the torque limiter 1, three planetary gears 23 which are respectively engaged with the sun gear 21 and rotatably mounted on the respective support shafts 22, a lid 24 by which the planetary gears 23 are mounted to the support shafts 22, the internal gear 25 provided on the peripheral side of the planetary gears 23, a spline-shaped mounting hole 26 formed on the boss part 8 of a lower wheel 2 of the torque limiter 1, and a hinge pin receiving part which is an output part 28 and is inserted and fixed to the spline-shaped mounting hole 26 and having a receiving hole 27 for a hinge pin of the toilet seat or the seat lid.

The geared motor 13 is attached to only one of the seat lid and the toilet seat. Therefore, two geared motors 13 are used in order to automatically open or close both the seat lid and the toilet seat.

The first case 32, the second case 33 and the third case 34 are screwed with bolts 35 together. A support shaft 41 for the first gear 16 and a support shaft 42 for the second gear 18 are press-fitted and integrated with the second case 33, and a support hole 43 for the drive source 14 is formed on the second case 33. Therefore, the number of component parts can be reduced remarkably. Moreover, since the second case 33 supports the drive source 14, it is not necessary to use another member to support the drive source 14, and thus the increase of the number of component parts can be suppressed.

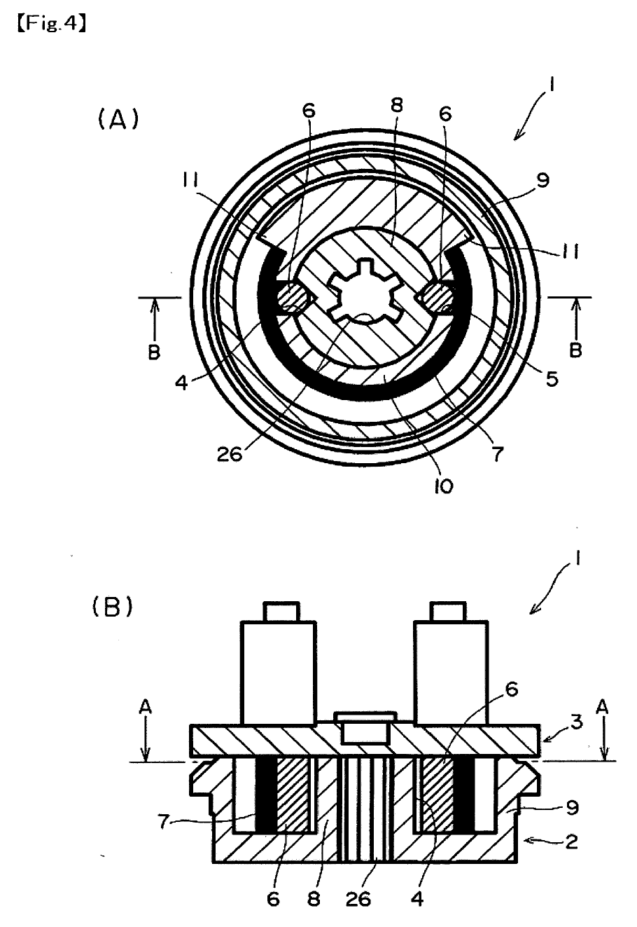

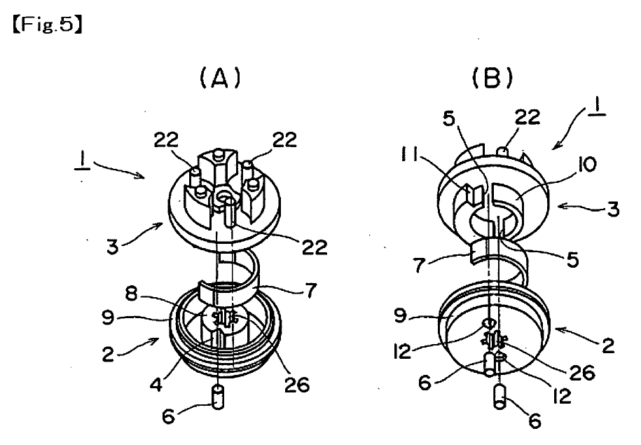

The torque limiter 1 includes the lower wheel 2 and the upper wheel 3 as shown in FIGS. 4 and 5. When an input torque applied to either of the lower wheel 2 or the upper wheel 3 is not more than a preset torque, the lower wheel 2 and the upper wheel 3 are interlocked to operate together. The torque limiter 1 is constructed such that an engaging groove 4 is formed on either of the lower wheel 2 and the upper wheel 3, and an engagement part 5 is formed on the other of the lower wheel 2 and the upper wheel 3, a roller pin 6 is engaged with both the engaging groove 4 and the engagement part 5, and a leaf spring 7 is provided for pressing and engaging the roller pin 6 to the engaging groove 4. When the input torque exceeds the preset torque, the roller pin 6 makes the leaf spring 7 deform elastically and disengages from the engaging groove 4. Therefore, the lower wheel 2 and the upper wheel 3 become in a non-interlocking state.

The lower wheel 2 is provided with a boss part 8 and an outer wall part 9. The upper wheel 3 is provided with a fitting circumferential wall part 10 which is rotatably fitted to the circumference of the boss part 8 of the lower wheel 2. The lower wheel 2 and the upper wheel 3 are rotatably assembled with the fitting circumferential wall part 10 of the upper wheel 3 fitted to the boss part 8 of the lower wheel 2. The engagement parts 5 are formed at two positions of the fitting circumferential wall part 10 at an interval of 180 degrees. The engaging grooves 4 are formed at two positions at an internal of 180 degrees on the outer peripheral face of the boss part 8 of the lower wheel 2. As a result, the lower wheel 2 and the upper wheel 3 are positioned at every 180 degrees so as to be fixed together.

The leaf spring 7 is formed in an arc shape over 180 degrees. The leaf spring 7 is fitted on the outer face of the fitting circumferential wall part 10 of the upper wheel 3 to cover the respective engagement parts 5. Since the leaf spring 7 is formed in the range over 180 degrees, two engagement parts 5 can be covered by the leaf spring 7 at the same time. A stopper 11 for preventing the leaf spring 7 from rotating is formed on the fitting circumferential wall part 10 at a portion where the leaf spring 7 is not fitted.

The roller pin 6 is disposed in the inside of each of the engagement parts 5 and is urged toward the inner side by the leaf spring 7. In FIG. 5, the notational symbol 12 indicates a through-hole for inserting the roller pin 6 into the inside of the lower wheel 2 from outside.

The geared motor 13 also includes a sensor circuit board 29 for detecting the rotation number of the first gear 16 and a lower wheel side sensor circuit board 30 for detecting the rotation angle of the lower wheel 2. Each of the sensor circuit boards 29, 30 detects the passing of a magnet disposed on the rotating side member by using a Hall integrated circuit 36 to detect the rotation angle or the like of the rotating side member. The sensor circuit board 29 is fixed to a mid case, i.e., the second case 33 with a bolt 37 and detects the passing of the magnet 39 disposed on the first pinion 17 side of the first gear 16 to detect the rotation number of the first gear 16. The magnet 39 is formed in a fan shape with, for example, eight poles. The lower wheel side sensor circuit board 30 is fixed to the lower case 34 with bolts 38 and detects the passing of a magnet disposed on the lower wheel 2 to detect the rotation angle of the lower wheel 2, i.e., the toilet seat or the seat lid.

An example of the operation of the geared motor 13 described above will be described below.

The geared motor 13 is mounted to a toilet stool side. Then, the hinge pin of the toilet seat or the seat lid is fixed to the output part 28. The rotation of the drive source 14 is transmitted to the upper wheel 3 through the route of following: the first gear 16→the first pinion 17→the second gear 18→the second pinion 19→the third gear 20→the sun gear 21→the planetary gears 23, and then the upper wheel 3 of the torque limiter 1 is rotated. When the roller pin 6 engages with the engaging groove 4, the boss part 8 of the lower wheel 2 and the fitting circumferential wall part 10 of the upper wheel 3 are integrally connected through the roller pin 6. Therefore, the lower wheel 2 and the upper wheel 3 are interlocked and rotated.

As a result, the rotation of the upper wheel 3 is transmitted to the lower wheel 2 and then transmitted from the lower wheel 2 to the toilet seat or the seat lid through the output part 28. Consequently, the toilet seat or the seat lid is automatically opened or closed.

When a large torque is applied to the lower wheel 2 or the upper wheel 3, the edge portion of the engaging groove 4 pushes the roller pin 6 outer side and pushes out from the engaging groove 4 against the leaf spring 7. As a result, the lower wheel 2 and the upper wheel 3 idle relatively without being interlocked. When the torque is reduced, the roller pin 6 is pushed into the engaging groove 4 by the urging force of the leaf spring 7 at the time the roller pin 6 is located at the engaging groove 4. As a result, the lower wheel 2 and the upper wheel 3 become to be in a state such that they can be interlocked and rotated.

The rotation number of the first gear 16 is detected with the sensor circuit board 29 during operation and thus it can be detected whether the drive source 14 is driven normally or not. The rotation angle of the lower wheel 2 is detected with the lower wheel side sensor circuit board 30 and thus the opening and closing state of the toilet seat or the seat lid can be obtained.

According to the embodiment of the present invention, since the second case 33 and the internal gear 25 are integrally formed to enhance the strength, the torque limiter 1 provided at the succeeding stage of the deceleration transmission mechanism 40 can be properly operated. Further, since the torque limiter 1 is provided between the seat lid or the toilet seat and the drive source 14, the teeth of the gear can be prevented from damaging even when an excessive torque is applied between the seat lid or the toilet seat and the drive source 14.

The present invention has been described in detail by using the embodiments, but the present invention is not limited to the embodiments described above and many modifications can be made without departing from the present invention. For example, in the embodiment described above, the internal gear 25 and the second case 33 are formed in an integral manner. However, another gear and the second case 33 may be formed over in an integral manner.

Further, in the embodiment described above, the internal gear 25 is formed over the whole circumference on the internal face of the second case 33. However, the present invention is not limited to the embodiment described above. For example, the internal gear 25 may be formed over only a part of the internal face of the second case 33 according to the application of the geared motor 13.

In addition, in the embodiment described above, the second case 33 is screwed to the first case 32 and the third case 34. However, the present invention is not limited to the embodiment described above. For example, the second case 33 may be mounted so as to be movable with respect to the first case 32 and the third case 34.

Furthermore, in the embodiment described above, the geared motor is used in the automatic opening/closing unit for the toilet seat and the seat lid. However, the present invention is not limited to the embodiment described above.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A geared motor comprising:
a drive source;
a deceleration transmission mechanism which is connected to the drive source for decelerating and transmitting a rotation output of the drive source to an output part;
a first case which fixes the drive source;
a second case which forms a space for accommodating the drive source together with the first case and supports the deceleration transmission mechanism; and
a third case which covers the deceleration transmission mechanism,
wherein a part of the deceleration transmission mechanism is formed with the second case in an integral manner.

2. The geared motor according to claim 1, wherein the deceleration transmission mechanism includes a planetary gear mechanism which comprises:
a sun gear which transmits the rotation output from the drive source;
a planetary gear which revolves around the sun gear while rotating; and
an internal gear which is integrally formed on the second case and engages with the planetary gear.

3. The geared motor according to claim 2, wherein the internal gear is formed on an inner peripheral face of an aperture part formed on the second case.

4. The geared motor according to claim 1, further comprising a torque limiter which is provided between the deceleration transmission mechanism and the output part and which operates to output a same torque as an input torque when the input torque which is the same is not more than a preset torque and not to output a torque when the input torque exceeds the preset torque.

5. The geared motor according to claim 1, wherein the second case supports the drive source.

6. The geared motor according to claim 5, wherein the second case is provided with a support hole into which a motor as the drive source is inserted and supported, and a motor pinion fixed to a rotation shaft of the motor is disposed between the second case and the third case.
